(19) United States
(12) Patent Application Publication
(10) Pub. No.: US 2016/0175846 A1
(43) Pub. Date: Jun. 23, 2016

(54) REDUCING OF ONE-SIDED TWISTING OF A PITMAN IN A MINERAL MATERIAL PROCESSING PLANT

(71) Applicant: METSO MINERALS, INC., Helsinki (FI)

(72) Inventor: Jari Jonkka, Kangasala (FI)

(73) Assignee: Metso Minerals, Inc., Helsinki (FI)

(21) Appl. No.: 14/893,155

(22) PCT Filed: May 27, 2014
(86) PCT No.: PCT/FI2014/050414

§ 371 Date: Nov. 23, 2015

(30) Foreign Application Priority Data
Jun. 10, 2013 (FI) 20135635

(51) Int. Cl. B02C 1/02; B02C 1/04

(52) U.S. Cl. CPC B02C 1/025; B02C 1/04

(57) ABSTRACT

A crusher for crushing mineral material, a method for decreasing twisting of a pitman in a crusher and a mineral material processing plant. The crusher includes a fixed crushing element and a pitman as a crushing element configured to be movable. The crusher includes at least two hydraulic cylinders and a piston in each hydraulic cylinder and a piston rod attached to the piston and extending through a first end of the hydraulic cylinder and being in connection with the movable crushing element. The crusher includes a hydraulic fluid connecting channel between the at least two hydraulic cylinders which connecting channel is connected to a hydraulic fluid space of the hydraulic cylinder to be pressurized by the crushing force. The connecting channel is dimensioned so that the diameter of the hydraulic fluid space of said hydraulic cylinder is at least 25 times larger than the diameter of the connecting channel.

### FIELD OF INVENTION

The invention relates generally to protecting of a jaw crusher by a hydraulic safety apparatus in an overload situation. Particularly, but not exclusively, the invention relates to reducing twisting of a pitman caused by one-sided crushing forces during operation of a jaw crusher.

### BACKGROUND OF THE INVENTION

A jaw crusher is a device suitable for crushing stone. FIG. 1 shows a known jaw crusher 100 at maximum setting and FIG. 2 shows the jaw crusher of FIG. 1 at minimum setting. A jaw crusher comprises two crushing elements i.e. jaws 10 that are arranged to receive the forces generated during operation of the crusher or for example while changing the setting of the crushing elements. One crushing element is a substantially immobile fixed jaw supported on a frame 4, and the other crushing element is a jaw attached to a pitman and configured to be movable. The crusher further comprises a pitman 11 attached through a bearing from the top end thereof to an eccentric shaft 12 causing the top end of the pitman 11 to rotate around a centre axis of the eccentric. A toggle plate 1 functioning as a linkage for the pitman and supporting the pitman 11 is situated between the bottom end of the pitman and a rear end of the jaw crusher. The toggle plate and the eccentric shaft provide for the desired kinematics of the pitman in order to achieve effective crushing. The toggle plate is attached at one end with specific connecting elements to the pitman and at the other end to piston rods of pistons of hydraulic cylinders 9 functioning as a safety apparatus in such a way that the piston rods are in connection with the crushing element configured to be movable. Both ends of the toggle plate 1 comprise connection elements 3 that comprise toggle plate bearings between the pitman 1 and the connecting elements 3. The upper connecting element is fitted between guide elements 6 in such a way that during the crusher setting adjustment or during an overload situation, the connecting element can glide along the guide elements towards the hydraulic cylinder while the piston is pressed further into the cylinder. The piston of the hydraulic cylinder of the safety apparatus supports the movable jaw from the outer side.

If the force or strain incident on the movable jaw is too large, the toggle plate may give in, i.e. a so called buckling takes place, and thus protect the crusher from further damage. In addition to the toggle plate, the hydraulic cylinder and a pressure relief valve 14, in other words, a safety valve in connection with the hydraulic cylinder form a further safety apparatus, since the space 16 behind the piston has a connection through the safety valve to a hydraulic fluid tank. The safety apparatus is adjusted so that when crushing materials the pressure of the hydraulic fluid in the cylinders of the safety apparatus remains below an opening pressure of the pressure relief valve. The pressure relief valve opens first in an overload situation when the pressure in the cylinders 9 caused by uncrushable material exceeds the opening pressure.

The crusher according to FIGS. 1 and 2 further comprises a return cylinder 2 which is a double acting cylinder. The return cylinder is attached to the crusher frame for example at a bracket next to the cylinder 9 of the safety apparatus. The return cylinder is connected to a pressure accumulator 15 that holds the piston rod side of the return cylinder pressurized during operation in order to ensure tension. The return cylinder 2 is also utilized in enlarging the setting, since the cylinder 9 of the safety apparatus is single acting.

FIG. 3 shows a system 300 that demonstrates the functioning of the hydraulic cylinder 9 of the safety apparatus. The hydraulic cylinder 9 has a piston 316 dividing the volume of the cylinder into a pressure space 312 and opposite space 314, i.e. the piston rod 318 side space. The piston rod 318 receives the load or force incident on the piston from the toggle plate. The load causes a pressure equivalent to the amount of force divided by the cross-sectional area of the cylinder into the pressure space 312. As the pressure exceeds a given pressure threshold, a pressure relief valve PRV 14 connected to the pressure space 312 allows hydraulic fluid from the pressure space to a hydraulic fluid tank 320 whereupon the toggle plate and the movable jaw are allowed to give before the excessive load. This is beneficial for example if uncrushable material such as steel or the like ends up between the jaws. The piston 316 is driven back to its desired position by pumping hydraulic fluid into the pressure space 312 with a pump 330. A valve 340 is used to control the filling of the pressure space 312 in such a way as to steer the piston 316 to its desired position.

FIGS. 4a and 4b show how the hydraulic cylinders 9 of the safety apparatus acting to the toggle plate 1 are connected to each other by large-diameter connecting channels 17 (steel pipe) before a pressure relief valve (not shown in the figure) to have same pressure in all cylinders and that the cylinders would receive evenly the force directed to the toggle plate. Before the crushing impact the pressure of the cylinder is p. In FIG. 4a a resultant of the crushing force F is directed centrally to a crushing chamber and the toggle plate 1 and is divided evenly to all piston rods 318. The pressure p raises to pressure p₁ in the cylinders. A large amount of oil flows in the large-diameter connecting channel 17 that the same pressure would prevail in all cylinders. After the work stroke the force F directed to the piston rods drops to nil whereupon also the pressure in the cylinders decreases to p.

In FIG. 4b the resultant of the crushing force F is directed to a side of a pitman and is divided through the toggle plate 1 unevenly to the piston rods 318. The pressure p raises at place of the load to pressure p₁ in the cylinder on the left side and also in the other cylinders the pressure p raises to p₁ because during a quick work stroke hydraulic fluid flows freely to the neighboring cylinders wherein the neighboring piston rods move outwardly. The movement of the piston rods located centrally and on the right side and moving outwardly stops when the force corresponding to the pressure p₁ is attained. One can understand from FIG. 4b that the pitman twists. The twisting of the pitman strains the construction, bearings, eccentric shaft of the pitman, and the frame of the crusher shortening the life thereof. The twisting of the pitman further causes lateral moving of the toggle plate in the toggle plate bearings and thus wearing thereof. The twisting of the pitman may cause falling of the wear part of the movable jaw during the crushing.

The crushing elements, the pitman and the cylinders 9 of the safety apparatus of the jaw crusher receive large crushing forces during crushing and move several times per second. The required wear resistance is taken into account in the structure of the jaw crusher by using sufficiently large material strengths and wear resistant surfaces in such a way that on one hand a sufficient durability is reached and on the other hand creating costs is avoided. In addition, the crushing capacity of the jaw crusher that is dependent on the efficiency of the crushing impacts is sought to be maximized and the energy consumption of the crusher is sought to be minimized.

Patent publication FI20095429 (A) shows an arrangement with which undesired give of a cylinder can be reduced in order to increase the efficiency of a crusher.

The purpose of the invention is to avoid or lessen problems related to the state of the art and/or provide new technical alternatives.

### SUMMARY

The inventor has noted that during crushing when the crushing force presses the side of the jaw fixed to the pitman of the jaw crusher, only the piston of the hydraulic cylinder located at that side is pressed further into the cylinder in the safety apparatus whereupon the oil in the cylinder discharges quickly into the central and the other side cylinder and the pistons of the central and the other side cylinders move outwardly and the pitman twists. A repeated twisting of the pitman substantially exposes the joints between the cylinder and the jaw crusher pitman to wear. The inventor has also noted that said twisting of the pitman decreases the efficiency of the crusher, as it decreases the power of the crushing impacts. The inventor has further noted that in the state of the art undesired give is sought to be reduced with complicated technical arrangements thus increasing costs and decreasing operational reliability.

According to a first example aspect of the invention there is provided a crusher for crushing mineral material comprising a substantially fixed crushing element and a pitman as a crushing element configured to be movable, which crushing elements are arranged to receive a crushing force, the crusher further comprising:

at least two hydraulic cylinders and a piston in each hydraulic cylinder;

a piston rod attached to the piston and extending through a first end of the hydraulic cylinder and being in connection with the crushing element configured to be movable;

a hydraulic fluid connecting channel between said at least two hydraulic cylinders which connecting channel is connected to a hydraulic fluid space of the hydraulic cylinder to be pressurized by the crushing force; and

said connecting channel is dimensioned so that the diameter of a circle corresponding to the flow area of said hydraulic cylinder is at least 25 times larger than the diameter of a circle corresponding to the flow area of the connecting channel.

According to a second example aspect of the invention there is provided a crusher for crushing mineral material comprising a substantially fixed crushing element and a pitman as a crushing element configured to be movable, which crushing elements are arranged to receive a crushing force, the crusher further comprising:

at least two hydraulic cylinders and a piston in each hydraulic cylinder;

a piston rod attached to the piston and extending through a first end of the hydraulic cylinder and being in connection with the crushing element configured to be movable;

a hydraulic fluid connecting channel between said at least two hydraulic cylinders which connecting channel is connected to a hydraulic fluid space of the hydraulic cylinder to be pressurized by the crushing force; and

said connecting channel is dimensioned so that the diameter of the hydraulic fluid space, to be pressurized by the crushing force, of said hydraulic cylinder is at least 25 times larger than the flow diameter of the connecting channel.

Preferably the diameter of the hydraulic cylinder is at least 25 times larger than the diameter of the connecting channel.

Preferably the connecting channel is dimensioned so that the diameter of the circle corresponding to the flow area of said hydraulic cylinder is at least 45 times larger than the diameter of a circle corresponding to the flow area of the connecting channel.

Preferably the connecting channel is configured during crushing to form a pressure loss of at least 30 bar, more preferably a pressure loss ΔP of at least 50 bar. Preferably the pressure loss is formed when there is crushed in the range of an adjusted maximum pressure of a safety valve (pressure relief valve) of a hydraulic safety apparatus of the crusher, and when the crushing force (caused by a quick crushing movement) is directed one-sided to the outermost hydraulic cylinder of the crusher.

Preferably the flow area of the connecting channel is the smallest flow area of the connecting channel.

Preferably a throttle is arranged to the connecting channel defining the smallest flow area of the connecting channel.

Preferably the connecting channel is configured to enable the flow of the hydraulic fluid between the hydraulic cylinders in a slow adjustment movement of the hydraulic cylinder for example in the setting adjustment.

Preferably adding of the hydraulic fluid is arranged at place of the central hydraulic cylinder preferably into the connecting channel. Hydraulic fluid can be added for example when the setting is adjusted smaller.

Preferably the crusher comprises three hydraulic cylinders that are connected by the connecting channels.

According to a third example aspect of the invention there is provided a mineral material processing plant that comprises a crusher according to the first or second aspect of the invention.

Preferably the mineral material processing plant is a mobile processing plant.

According to a fourth example aspect of the invention there is provided a method for reducing twisting of a pitman in a crusher, said crusher comprising a substantially fixed crushing element and the pitman as a crushing element configured to be movable, which crushing elements are arranged to receive a crushing force, the method comprising:

supporting the crushing element configured to be movable with an apparatus comprising at least two hydraulic cylinders, and a piston, a piston rod and hydraulic fluid in each cylinder, and connecting channels connecting said hydraulic cylinders, the connecting channels being connected to a hydraulic fluid space of the hydraulic cylinder pressurized by the crushing force; and

dimensioning said connecting channel so that the diameter of a circle corresponding to the flow area of said hydraulic cylinder is at least 25 times larger than the diameter of a circle corresponding to the flow area of the connecting channel.

According to a fifth example aspect of the invention there is provided a method for reducing twisting of a pitman in a crusher, said crusher comprising a substantially fixed crushing element and the pitman as a crushing element configured to be movable, which crushing elements are arranged to receive a crushing force, the method comprising:

supporting the crushing element configured to be movable with an apparatus comprising at least two hydraulic cylinders, and a piston, a piston rod and hydraulic fluid in each cylinder, and connecting channels connecting said hydraulic cylinders, the connecting channels being connected to a hydraulic fluid space of the hydraulic cylinder pressurized by the crushing force; and

dimensioning said connecting channel so that the diameter of the hydraulic fluid space, to be pressurized by the crushing force, of said hydraulic cylinder is at least 25 times larger than the flow diameter of the connecting channel.

Preferably dimensioning the diameter of the hydraulic cylinder at least 25 times, more preferably at least 45 times, larger than the diameter of the connecting channel.

Preferably dimensioning said connecting channel so that the diameter of the circle corresponding to the flow area of said hydraulic cylinder is at least 45 times larger than the diameter of a circle corresponding to the flow area of the connecting channel.

Preferably forming during crushing a pressure loss of at least 30 bar, more preferably a pressure loss ΔP of at least 50 bar, in the connecting channel.

Preferably forming the pressure loss when there is crushed in the range of an adjusted maximum pressure of a safety valve (pressure relief valve) of a hydraulic safety apparatus of the crusher, and when the crushing force (caused by a quick crushing movement) is directed one-sided to the outermost hydraulic cylinder of the crusher.

Preferably defining the smallest flow area of the connecting channel by a throttle.

Preferably enabling the flow of the hydraulic fluid between the hydraulic cylinders in a slow adjustment movement of the hydraulic cylinder for example in the setting adjustment.

Preferably adding hydraulic fluid at place of the central hydraulic cylinder preferably into the connecting channel.

Different embodiments of the present invention will be illustrated or have been illustrated only in connection with some aspects of the invention. A skilled person appreciates that any embodiment of an aspect of the invention may apply to the same aspect of the invention and other aspects alone or in combination with other embodiments as well.

### BRIEF DESCRIPTION OF THE DRAWINGS

The invention will now be described, by way of example, with reference to the accompanying drawings.

FIG. 1 shows a cross-section of a known jaw crusher at maximum setting;

FIG. 2 shows a cross-section of the jaw crusher of FIG. 1 at minimum setting;

FIG. 3 shows a schematic representation of a hydraulic safety apparatus of the jaw crusher of FIG. 1;

FIG. 4a shows schematically the principle of the functioning of cylinders of the hydraulic safety apparatus of FIG. 3 during working stroke when the crushing force F is directed centrally to a pitman;

FIG. 4b shows the principle of the functioning of the cylinders of FIG. 4a during working stroke when the crushing force F is directed to the side of the pitman;

FIG. 5a shows schematically the principle of the functioning of cylinders of a hydraulic safety apparatus according to the invention during working stroke when the crushing force F is directed centrally to a pitman;

FIG. 5b shows the principle of the functioning of the cylinders of FIG. 5a during working stroke when the crushing force F is directed to the side of the pitman;

FIG. 6 shows schematically pressure losses ΔP as a function of a ratio of cylinder diameter D_{CYL} and connecting channel diameter D_{CH}, the pressure losses present in some apparatuses according to the invention and formed in a connecting channel between cylinders;

FIG. 7 shows a mineral material processing plant according to the invention.

### DETAILED DESCRIPTION

In the following description, like numbers denote like elements. It should be appreciated that the illustrated drawings are not entirely in scale, and that the drawings mainly serve the purpose of illustrating embodiments of the invention.

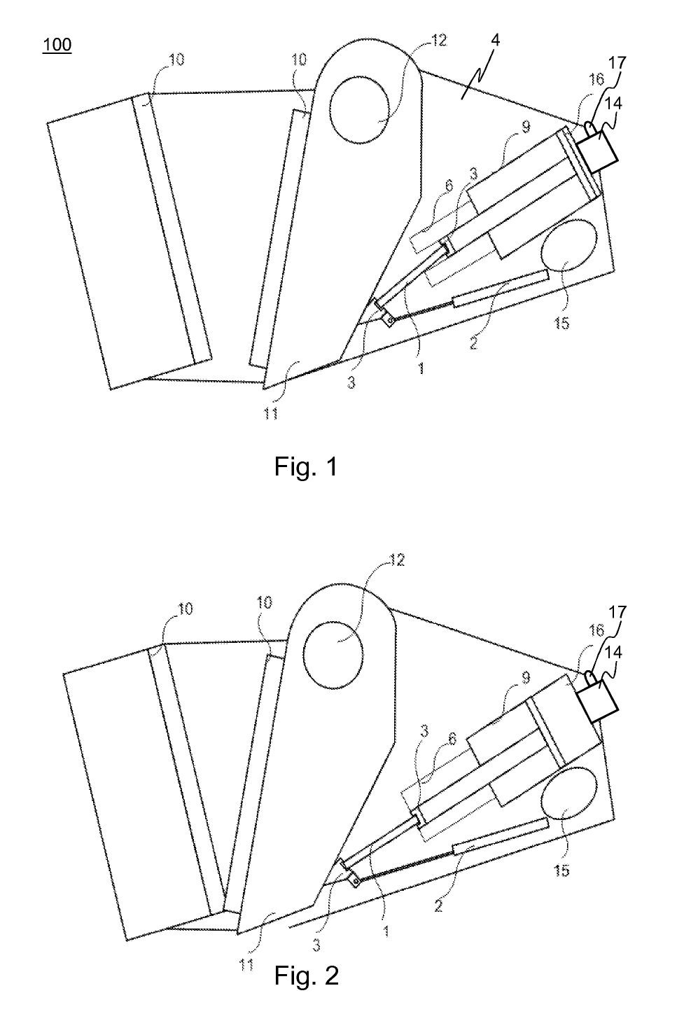

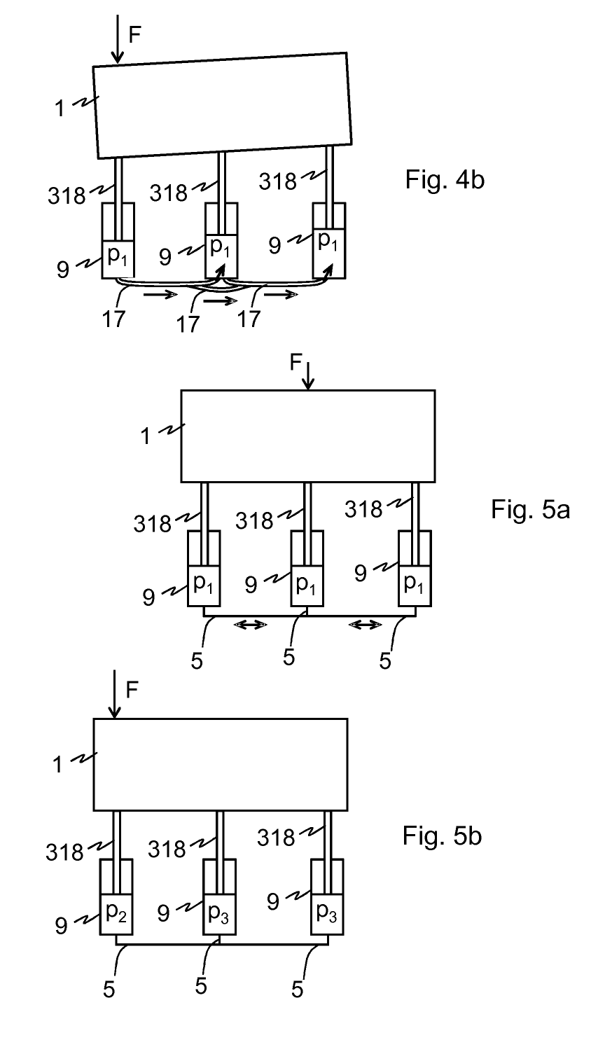

FIGS. 1-4b have been explained in connection with the background of the invention. The inventor has noted that the undesired twisting of the pitman made possible by the safety apparatus hereinbefore described can be reduced with a simple and cost effective solution. A jaw crusher according to FIGS. 1 and 2 can be used as an environment of different embodiments of the present invention in such a way that instead of the safety apparatus of FIGS. 1 and 2 an apparatus according to an embodiment of the invention is used, for example the apparatus according to FIGS. 5a and 5b. With the help of different embodiments of the invention the crusher can be scaled for reduced wear, as the twisting of the pitman can be reduced compared to previous solutions.

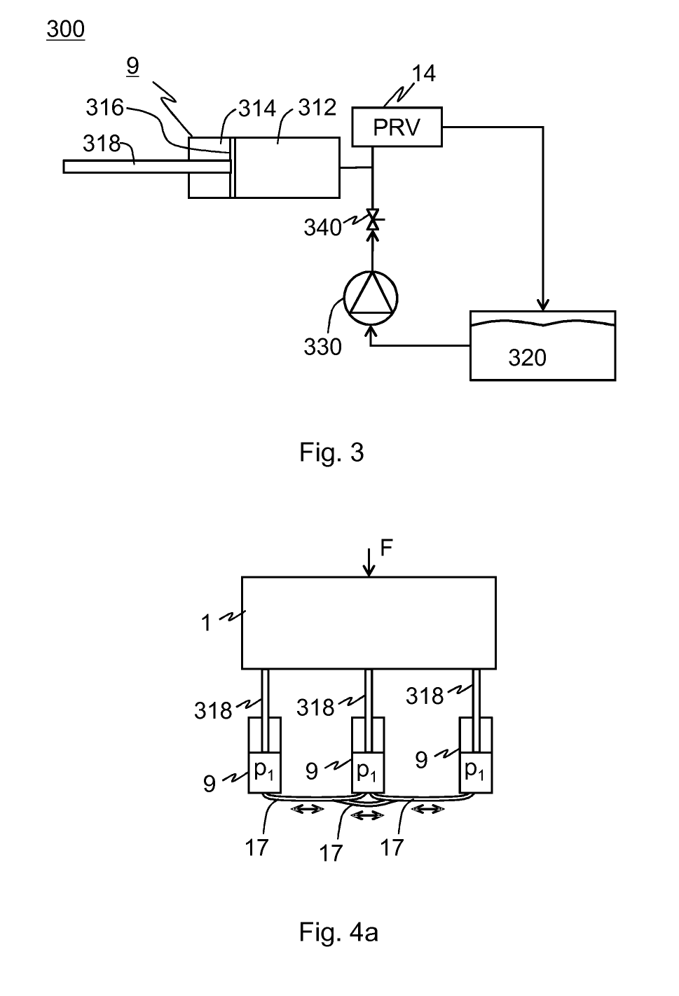

FIGS. 5a and 5b show that the hydraulic cylinders 9 acting to the toggle plate 1 are connected to each other by small-diameter (flow diameter) connecting channels 5 so that the crushing forces acting to the toggle plate at the side of the crushing chamber do not have time to cause a large volume discharging of hydraulic oil from the (for example outermost) hydraulic cylinder 9 being target of the crushing force. By the small flow diameter of the connecting channel 5 is meant in this connection also that the diameter D_{CH} of the connecting channel 5 included in the safety apparatus of a certain crusher is dimensioned relative to the diameter D_{CYL} of the cylinder 9 of that crusher. By the cylinder diameter is meant here a functional inner diameter of the hydraulic fluid volume of the cylinder 9, the hydraulic fluid volume being pressurized by the crushing force. By the cylinder diameter can in other words be understood also the functional diameter of the piston. One hydraulic fluid volume 312 being pressurized by the crushing force is shown in FIG. 3.

According to some embodiments in order to achieve an improvement according to the invention the connecting channel 5 diameter D_{CH}≦12.7 mm (½ inches), for example D_{CH}≦6.35 mm (¼ inches), but a skilled person understands that when the size of the cylinder is changed also the size of the connecting channel may change because an object of the invention is to slow down the discharging of the hydraulic liquid from the hydraulic cylinder during a quick crushing stroke being divided in an exceptional way.

Better than by the sole size of the connecting channel, the invention is described by a ratio D_{CYL}/D_{CH} of the diameter D_{CYL} of the cylinder 9 and the diameter D_{CH} of the connecting channel 5 being preferably more than 25. According to some embodiments D_{CYL}/D_{CH}>45. The diameter of the connecting channel 5 means preferably the smallest diameter of the connecting channel between the cylinders. Naturally the cylinder 9 and the connecting channel 5 can have a cross-section deviating from a circle so that preferably the connecting channel is dimensioned so that the diameter of a circle corresponding to the flow area of (the cross-section of) said hydraulic cylinder is at least 25 times larger than the diameter of a circle corresponding to the flow area of the connecting channel.

Before the crushing stroke the pressure of the cylinder is p. In FIG. 5a the crushing force is directed centrally towards the crushing chamber and the toggle plate 1 and is divided evenly to all piston rods 318. The piston rod 318 receives the load or force coming from the toggle plate to the piston. The load causes a pressure in the pressure space of the cylinder, the amount of the pressure being the amount of the force divided by the cross-sectional area of the cylinder. The pressure p increases in the cylinders to pressure p₁. If necessary a small amount of oil flows in the small-diameter connecting channels 5 between the cylinders 9 that same pressure would prevail in all cylinders. After a work stroke the crushing force directed to the piston rods drops to nil whereupon also the pressure of the cylinders lowers to p.

In FIG. 5b the crushing force resultant F is directed to the side of the pitman and is divided unevenly to the piston rods 318 through the toggle plate 1. Before the crushing stroke the pressure of the cylinder is p. The pressure increases in the cylinder at place of the load on the left side of the toggle plate to pressure p₂. In the other cylinders the pressure p₃ remains close to the magnitude p, but clearly lower than p₁, because during the quick work stroke the hydraulic liquid has no time to flow in the small-diameter connecting channels 5 to the neighboring cylinders, whereupon the neighboring piston rods remain in place. One can understand from FIG. 5b that the twisting of the pitman ends or at least decreases substantially wherein the lifetime of the pitman and the toggle plate, the crusher frame and the bearings increases.

In the adjustment of the setting of the crusher the small-diameter connecting channel 5 is sufficient because in the setting adjustment the desired movement speed of the cylinder 9 piston is very low in relation to the quick work strokes.

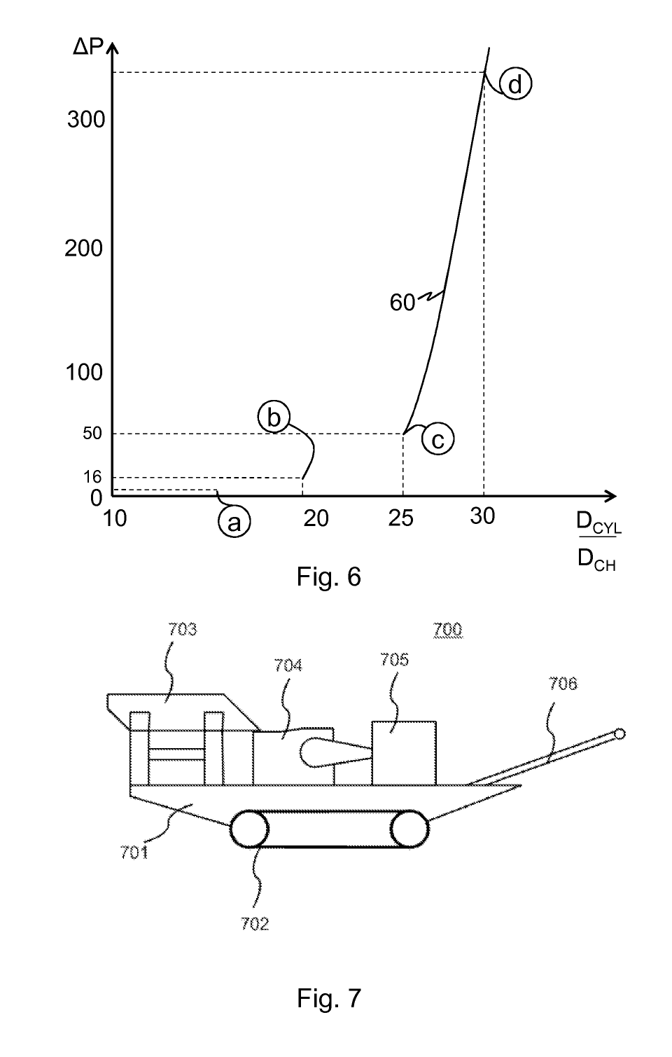

A calculated curve 60 of FIG. 6 shows pressure losses ΔP as a function of a ratio of cylinder diameter D_{CYL} and connecting channel diameter D_{CH}, the pressure losses being present in some apparatuses according to the invention and formed in the connecting channel 5 between the cylinders 9. The curve 60 is formed by connecting points c-d, the pressure loss ΔP formed in the connecting channel 5 and represented by these points being substantially higher than in prior art, wherein hydraulic oil is not able to flow through the small-diameter connecting channel 5 as quick as in the known solution. For comparison, there are shown points a and b present in an apparatus according to prior art.

In FIG. 6 the point a represents a prior art situation where the ratio of the hydraulic cylinder diameter D_{CYL} 240 mm and the flow diameter D_{CH} 15.9 mm (⅝ inches) of the connecting channel (with relative large diameter) between the neighboring cylinders of a first jaw crusher (width of the crushing chamber ca. 1000 mm) is ca. 15 and the formed computational pressure loss ΔP is ca. 5 bar in a crushing situation corresponding to the opening pressure 300 bar of the safety valve PRV 14. The point b represents a prior art situation where the ratio of the hydraulic cylinder diameter D_{CYL} 240 mm and the flow diameter D_{CH} 12.7 mm (½ inches) of the connecting channel between the neighboring cylinders of this first jaw crusher is ca. 19 and the formed computational pressure loss ΔP is ca. 16 bar in the crushing situation corresponding to the opening pressure 300 bar of the safety valve PRV 14.

In an apparatus according to an embodiment of the invention in this first jaw crusher (width of the crushing chamber ca. 1000 mm) the ratio of the hydraulic cylinder 9 diameter D_{CYL} 240 mm and the flow diameter D_{CH} 6.35 mm (¼ inches) of the connecting channel 5 (with relative small diameter) between the neighboring cylinders is ca. 38 and the formed computational pressure loss ΔP is ca. 620 bar in the crushing situation corresponding to the opening pressure 300 bar of the safety valve PRV 14 (not shown in the curve 60).

The point c represents a situation in a second apparatus (width of the crushing chamber ca. 1200 mm) according to an embodiment of the invention where the ratio of the hydraulic cylinder 9 diameter D_{CYL} 300 mm and the flow diameter D_{CH} 11.6 mm of the connecting channel 5 (with relative small diameter) between the neighboring cylinders is ca. 26 and where the formed computational pressure loss ΔP is ca. 50 bar in a crushing situation corresponding to an opening pressure 250 bar of the safety valve PRV 14. Further in the second apparatus according to an embodiment of the invention where the ratio of the hydraulic cylinder 9 diameter D_{CYL} 300 mm and the flow diameter D_{CH} 6.35 mm (¼ inches) of the connecting channel 5 (with relative small diameter) between the neighboring cylinders is ca. 47 and where the formed computational pressure loss ΔP is ca. 1000 bar in a crushing situation corresponding to the opening pressure 250 bar of the safety valve PRV 14 (not shown in the curve 60).

The point d represents a situation in a third apparatus (width of the jaw crusher crushing chamber ca. 950 mm) according to an embodiment of the invention where the ratio of the hydraulic cylinder 9 diameter D_{CYL} 200 mm and the flow diameter D_{CH} 6.35 mm (¼ inches) of the connecting channel 5 (with relative small diameter) between the neighboring cylinders is ca. 31 and where the formed computational pressure loss ΔP is ca. 340 bar in a crushing situation corresponding to an opening pressure 300 bar of the safety valve PRV 14.

FIG. 7 shows a mobile mineral material processing plant 700 comprising a feeder 703 for feeding material into a crusher 704, such as into a jaw crusher, and a belt conveyor 706 for conveying the crushed product further away from the processing plant. The crusher depicted in the figure is preferably a jaw crusher comprising an apparatus according to an embodiment of the invention for reducing twisting of the pitman. The processing plant 700 further comprises a power source and a control centre 705. The power source may be for example a diesel or electric engine that provides energy for the process units and hydraulic circuits.

The feeder, the crusher, the power source and the conveyor are attached to a frame 701 which in this embodiment further comprises a track base 702 for moving the processing plant. The processing plant may also be completely or in part wheel-based or movable on legs. Alternatively, it may be movable or towable with for example a truck or other external power source. In addition to the hereinbefore, the processing plant may also be a stationary processing plant.

Without in any way limiting the scope, interpretation or possible applications of the invention, an improvement of the energy consumption and capacity of a mineral material processing plant can be considered a technical advantage of different embodiments of the invention. Furthermore, an increased lifetime of components of a mineral material processing plant can be considered a technical advantage of different embodiments of the invention. Furthermore, an increased environmental friendliness of a mineral material processing plant can be considered a technical advantage of different embodiments of the invention. Furthermore, an increase of operational reliability of a mineral material processing plant can be considered a technical advantage of different embodiments of the invention.

The twisting of the pitman 11 and the toggle plate 1 caused by the crushing force F is substantially reduced because oil from the outermost loaded cylinder 9 is not able to flow through the small-diameter connecting channel 5 as quickly as in the known solution. The attachment of the movable jaw (wear part) functions better because the pitman does not twist during crushing. The smaller deflection during the crushing increases efficiency and the energy consumption is decreased.

The foregoing description provides non-limiting examples of some embodiments of the invention. It is clear to a person skilled in the art that the invention is not restricted to details presented, but that the invention can be implemented in other equivalent means.

Some of the features of the above-disclosed embodiments may be used to advantage without the use of other features. As such, the foregoing description shall be considered as merely illustrative of the principles of the invention, and not in limitation thereof. Hence, the scope of the invention is only restricted by the appended claims.

1. A crusher for crushing mineral material including a substantially fixed crushing element and a pitman as a crushing element configured to be movable, which crushing elements are arranged to receive a force, the crusher further comprising:
at least two hydraulic cylinders and a piston in each hydraulic cylinder;
a piston rod attached to the piston and extending through a first end of the hydraulic cylinder and being in connection with the crushing element configured to be movable;
a hydraulic fluid connecting channel between said at least two hydraulic cylinders which connecting channel is connected to a hydraulic fluid space of the hydraulic cylinder to be pressurized by the crushing force;
wherein said connecting channel is dimensioned so that the diameter of the hydraulic fluid space, to be pressurized by the crushing force, of said hydraulic cylinder is at least 25 times larger than the flow diameter of the connecting channel.

2. The crusher according to claim 1, wherein the connecting channel is dimensioned so that the diameter of the circle corresponding to the flow area of said hydraulic cylinder is at least 45 times larger than the diameter of a circle corresponding to the flow area of the connecting channel.

3. The crusher according to claim 1, wherein the connecting channel is configured during crushing to form a pressure loss of at least 30 bar.

4. The crusher according to claim 1, wherein the flow area of the connecting channel is the smallest flow area of the connecting channel.

5. The crusher according to claim 1, wherein a throttle is arranged to the connecting channel defining the smallest flow area of the connecting channel.

6. The crusher according to claim 1, wherein the connecting channel is configured to enable the flow of the hydraulic fluid between the hydraulic cylinders in a slow adjustment movement of the hydraulic cylinder in the setting adjustment.

7. The crusher according to claim 1, wherein the crusher includes three hydraulic cylinders and adding of the hydraulic fluid is arranged at the central hydraulic cylinder.

8. A mineral material processing plant characterized in that the mineral material processing plant comprises a crusher according to claim 1.

9. The mineral material processing plant according to claim 8, characterized in that the mineral material processing plant is a mobile processing plant.

10. A method for reducing twisting of a pitman in a crusher, said crusher comprising a substantially fixed crushing element and the pitman as a crushing element configured to be movable, which crushing elements are arranged to receive a force, the method comprising:
supporting the crushing element configured to be movable with an apparatus comprising at least two hydraulic cylinders, a piston, a piston rod and hydraulic fluid in each cylinder, and connecting channels connecting said hydraulic cylinders, the connecting channels being connected to a hydraulic fluid space of the hydraulic cylinder pressurized by the crushing force; and
dimensioning said connecting channel so that the diameter of the hydraulic fluid space, to be pressurized by the crushing force, of said hydraulic cylinder is at least 25 times larger than the flow diameter of the connecting channel.

11. The method according to claim 10, wherein said connecting channel is dimensioned so that the diameter of the circle corresponding to the flow area of said hydraulic cylinder is at least 45 times larger than the diameter of a circle corresponding to the flow area of the connecting channel.

12. The method according to claim 10, further comprising the step of forming a pressure loss of at least 30 bar in the connecting channel.

13. The method according to claim 10 further comprising the step of defining the smallest flow area of the connecting channel by a throttle.

14. The method according to claim 10 further comprising the step of enabling the flow of the hydraulic fluid between the hydraulic cylinders in a slow adjustment movement of the hydraulic cylinder for example in the setting adjustment.

15. The method according to claim 10 further comprising the step of including three hydraulic cylinders and adding hydraulic fluid at place of the central hydraulic cylinder.

16. The method according to claim 10 wherein the flow area of the connecting channel is the smallest flow area of the connecting channel.

17. The method according to claim 10, further comprising the step of forming a pressure loss of at least 50 bar in the connecting channel.

18. The crusher according to claim 1, wherein the connecting channel is configured during crushing to form a pressure loss of at least 50 bar.
